(19) United States
(12) Patent Application Publication
(10) Pub. No.: US 2021/0281846 A1
(43) Pub. Date: Sep. 9, 2021

(54) METHOD OF MULTIPLE QUANTIZATION MATRIX SETS FOR VIDEO CODING

(71) Applicant: MEDIATEK INC., Hsin-Chu (TW)

(72) Inventors: Shih-Ta HSIANG, New Taipei City (TW); Shaw-Min LEI, Zhubei City, Hsinchu County (TW); Yu-Wen HUANG, Taipei City (TW); Yu-Chen SUN, Keelung City (TW)

(21) Appl. No.: 16/332,435

(22) PCT Filed: Sep. 13, 2016
(86) PCT No.: PCT/CN2016/098791

§ 371 Date: Mar. 12, 2019

(51) Int. Cl. H04N 19/126; H04N 19/176; H04N 19/167; H04N 19/70

(52) U.S. Cl. CPC H04N 19/126; H04N 19/70; H04N 19/167; H04N 19/176

(57) ABSTRACT

A method and apparatus for processing transform blocks of video data performed by a video encoder or a video decoder are disclosed. A plurality of quantization matrix sets are determined, where each quantization matrix set includes one or more quantization matrices corresponding to different block types. For a transform block corresponding to a current block in a current picture, a selected quantization matrix set is determined from the plurality of quantization matrix sets for the transform block. Quantization process or de-quantization process is applied to the transform block using a corresponding quantization matrix from the selected quantization matrix set.

### FIELD OF THE INVENTION

The present invention relates to video coding. In particular, the present invention relates to multiple quantization matrix sets for video coding to improve the coding performance.

### BACKGROUND OF THE INVENTION

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC and the emerging HEVC (High Efficiency Video Coding) standard.

FIG. 1 illustrates an exemplary adaptive Inter/Intra video coding system incorporating transform coding. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data are stored in Reference Picture Buffer 134 and used for prediction of other frames. However, loop filter 130 (e.g. deblocking filter and/or sample adaptive offset, SAO) may be applied to the reconstructed video data before the video data are stored in the reference picture buffer 134.

For coding systems utilizing transform coding, the quantization matrix (QM) has been used as a means to impose subjective quality measurement on the underlying video data. In particular, the quantization matrix is used in a video coding system for controlling the distribution of the quantization distortion across different frequencies in a transform unit (TU). The quantization matrix is often designed to take into account of the contrast sensitivity function (CSF) of the human visual system (HVS). The psychovisual experiments have found that the perceived sensitivity to luminance varies with spatial frequencies in cycles/degree and the eyes behave as a bandpass filter with a peak response around 2 to 10 cycles/degree (cpd) of the subtended visual angle depending on viewers and viewing conditions. The transform coefficients correspond to frequency-domain representation for the block of video data. To achieve perceptually uniform quantization across spatial frequencies, a quantization matrix can be designed to weight each frequency channel associated with the transform coefficient according to the perceived sensitivity over its related frequency range. The corresponding quantization matrix can be employed to inversely weight de-quantized transform coefficients at the decoder.

Quantization matrix has been used in various advanced video coding standards. For example, in H.265/HEVC (High Efficiency Video Coding), the information related to scaling matrices can be signalled in the sequence parameter set (SPS) and further updated in the picture parameter set (PPS). The scaling matrices are also called quantization matrices in this disclosure. The different scaling matrices are defined for transform units corresponding to different transform sizes, colour component indices, and coding unit (CU) prediction modes. A default set of the scaling matrices based on the human visual system (HVS) model is specified in H.265/HEVC. A method is disclosed to derive the large-size scaling matrix from the related small-size scaling matrix. In all existing video coding standards, such as MPEG-2, H.264/MPEG AVC and H.265/MPEG HEVC, only one set of the signalled scaling matrices for different TU types is available for decoding the entire picture.

It is desirable to develop technique to further improve the coding performance related to the transform coding.

### BRIEF SUMMARY OF THE INVENTION

A method and apparatus for processing transform blocks of video data performed by a video encoder or a video decoder are disclosed. A plurality of quantization matrix sets are determined, where each quantization matrix set includes one or more quantization matrices corresponding to different block types. For a transform block corresponding to a current block in a current picture, a selected quantization matrix set is determined from the plurality of quantization matrix sets for the transform block. Quantization process or de-quantization process is applied to the transform block using a corresponding quantization matrix from the selected quantization matrix set. In one embodiment, the block types are classified according to block sizes, block shape, block colour component indices, block prediction modes, or a combination thereof.

In one embodiment, the selected quantization matrix set is determined depending on a local region of the current block. The local region of the current block may correspond to one picture, one slice, one CTU (coding tree unit) or one CU (coding unit). One or more syntax elements indicating the selected quantization matrix set for the local region of the current block can be signalled by a video encoder. At the decoder side, the syntax elements are decoded from a video bitstream comprising compressed data of the local region of the current block. Information associated with the plurality of quantization matrix sets can be signalled from a video encoder to a video decoder so that the decoder can derive the quantization matrix sets from the video bitstream.

Furthermore, a plurality of quantization factors can be signalled for controlling quantization step sizes associated with quantization matrices of the plurality of quantization matrix sets. The values of the plurality of quantization factors can be determined independently for different quantization matrix sets.

Different quantization matrix sets are selected for blocks having different slice types or in different temporal layers. The quantization matrix sets can be determined for different local regions of a picture corresponding to different levels of human interest. In one embodiment, quantization matrix sets are determined for different local regions of a picture corresponding to different distances away from a picture centre. In another embodiment, the quantization matrix sets are determined for natural-scene video and at least one of the quantization matrix sets is determined for screen-content video.

In one embodiment, the quantization matrix set is derived based on quantization setting of a previous picture. The quantization setting for the previous picture may correspond to the quantization matrix set for a corresponding local region in the previous picture or quantization factors selected for the corresponding local region in the previous picture. In another example, the quantization setting for the previous picture corresponds to a syntax element specifying an absolute value of a difference between a luma quantization parameter of the current block and a quantization parameter predictor of the current block. A syntax element can be signalled in a slice level to indicate whether to enable derivation of the quantization matrix set based on the quantization setting for a previous picture. The quantization setting for the previous picture can be derived from quantization setting of collocated pixels in the previous picture corresponding to the current block.

### BRIEF DESCRIPTION OF THE DRAWINGS

FIG. 1 illustrates an exemplary adaptive Inter/Intra video coding system incorporating transform coding.

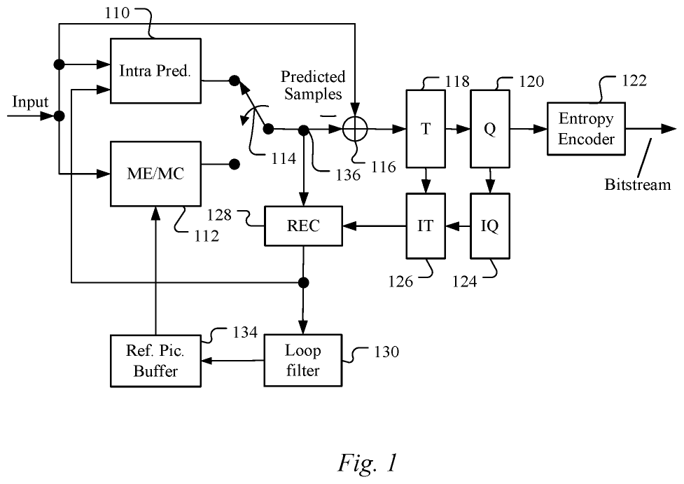

FIG. 2 illustrates a flowchart of an exemplary coding system using transform coding according to an embodiment of the present invention, where multiple quantization matrix sets are used.

FIG. 3 illustrates a flowchart of an exemplary coding system using transform coding according to an embodiment of the present invention, where the quantization matrix set is determined based on quantization setting of a previous picture.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In order to improve the coding efficiency, a coding method using multiple sets of quantization matrices is disclosed. According to this method, a plurality of quantization matrices is grouped into a quantization matrix set. Each set represents a collection of quantization matrices corresponding to different transform block size, shape, coding unit prediction mode, colour component index, or a combination thereof. For convenience, the term block type is used to refer to block size, block shape, block (e.g. coding unit) prediction mode, block colour component index, or any combination of them in this disclosure. The set of quantization matrices is selected for quantizing transform blocks in a local picture region. According to this method, more than one quantization matrix set is used. Multiple quantization matrix sets can be defined and enabled in different layers of bitstream data structure hierarchy, such as a coded video sequence (CVS), picture, and slice. The proposed method can adaptively select a quantization matrix set from the list of the enabled quantization matrix sets for each processing unit. The sample values from a transform unit are then quantized using a corresponding quantization matrix defined in the selected matrix set. The information related to quantization matrix sets can be coded in the high-level syntax bitstream sections such as the sequence parameter set (SPS) and/or picture parameter set (PPS).

Tables 1 and 2 provide exemplary syntax tables for representing the quantization scaling matrix sets according to one embodiment of the present invention. In Table 1, the syntax element scaling_list_enabled_flag indicates whether the quantization scaling matrices are employed in the current video sequence. The syntax element sps_scaling_list_data_present_flag equal to 0 indicates that the data of the scaling matrices (quantization matrices) are represented by the syntax table scaling_list_data( ) in the current SPS. Otherwise, the data of the scaling matrices are derived by some pre-defined methods. In Table 2, the syntax element num_scaling_matrix_sets_minus1 plus 1 indicates the number of the scaling matrix sets present in the current SPS. Each scaling matrix is represented or derived by some pre-defined method, as indicated by function scaling_matrix_data( ). The information can be further updated by some pre-defined methods as indicated in the PPS and slice header.

TABLE 1

Note

seq_parameter_set_rbsp( ) {

sps_video_parameter_set_id

....

scaling_list_enabled_flag
if( scaling_list_enabled_flag ) {

sps_scaling_list_data_present_flag
if( sps_scaling_list_data_present_flag )

scaling_list_data( )

}
....

}

TABLE 2

Note

```
scaling_list_data( ) {
  num_scaling_matrix_sets_minus1
  for( setId = 0; setId <= num_scaling_matrix_sets_minus1;
  setId++ ) {
```

for( matrixId = 0; matrixId < numScalingMatrics;
matrixId ++ )

scaling_matrix_data(setId, matrixId)

}
}

The selection of the scaling matrix set can be updated and signalled in units of slices, CTUs, or CUs. Table 3 provides an exemplary slice-level syntax table for selecting a scaling matrix set from a list of enabled scaling matrix sets defined in the SPS or PPS. In one embodiment, the proposed method comprises one scaling matrix set for coding the I-slices and multiple scaling matrix sets for coding the B-slices corresponding to different temporal layers for coding a video sequence. This collection of scaling matrix sets can be signalled in the SPS. The index of the selected scaling matrix set for coding each slice can be signalled in the slice header. In this way, the coding system does not need to further update the information related to quantization matrices in the PPS for coding pictures from different temporal layers.

TABLE 3

Note

slice_segment_header( ) {

....
if( scaling_list_enabled_flag ) {

slice_scaling_matrix_set_id

}
....

}

Tables 4 and 5 provide exemplary slice-level and CTU-level syntax tables according to another embodiment for supporting adaptive selection of quantization matrix on a CTU by CTU basis. The syntax element slice_num_scaling_matrix_sets_minus1 plus 1 indicates the number of scaling matrix sets to be enabled in the current slice. The syntax element slice_scaling_matrix_set_id[setId] maps an index of the list of the active scaling matrix sets defined in SPS or PPS to the slice index setId.

TABLE 4

Note

```
slice_segment_header( ) {
  ....
  slice_qp_delta
    ....
  if( scaling_list_enabled_flag ) {
```

```
  slice_num_scaling_matrix_sets_minus1
  for( setId = 0; setId <=
```

slice_num_scaling_matrix_sets_minus1; setId++ ) {

slice_scaling_matrix_set_id[setId]
slice_scaling_matrix_set_qp_delta[setId]

```
    }
  }
  ....
}
```

TABLE 5

Note

coding_tree_unit( ) {

....
if(slice_mum_scaling_matrix_sets_minus1 )

ctu_scaling_matrix_set_id

....

}

The proposed method further comprises a plurality of quantization factors for controlling the coarseness of quantizer step size used with different quantization matrices. In one embodiment, a quantization factor is signalled or derived for each quantization matrix. In another embodiment, a reference quantization factor is signalled or derived for each quantization matrix set. The reference quantization factor possibly with some further information can be utilized for deriving the quantization factor of each quantization matrix in this set. For example, the quantization factors of all quantization matrices can be set equal to the reference quantization factor for the luma component. Similarly, for the chroma components, the quantization factors of all quantization matrices can be set equal to a value derived from the reference quantization factor.

In another embodiment, a global reference quantization factor can be signalled or derived. The global reference quantization factor possibly with some further information can be utilized for deriving the reference quantization factor of a quantization matrix set. The quantization factors can be signalled and updated in different syntax structure units, such as the SPS, PPS, slice header, CTU, and CU. Table 4 provides an exemplary slice-level syntax table for deriving quantization factors according to an embodiment of the present invention. The syntax element slice_qp_delta can be employed to derive the global reference quantization factor in the current slice. The resulting global reference quantization factor and the decoded syntax element slice_scaling_matrix_set_qp_delta are employed for deriving the reference quantization factor for each quantization matrix set. The quantization factor of each quantization matrix in a quantization matrix set can be derived according to some pre-defined methods. When local adaptation of quantization factors is enabled, a quantization factor for the current control unit can be predicted from the related quantization factors in the neighbouring regions or the recently coded regions associated with the same quantization matrix set. The local adaptation of quantization factors can be applied in units of CU, TU or other local picture structure.

According to a study by Geisler et al. ((W. S. Geisler and J. S. Perry, “Real-time foveated multiresolution system for low-bandwidth video communication,” SPIE Proceedings, Vol. 3299, pp. 294-305, 1998.), it is found that the contrast sensitivity function is further related to retinal eccentricity, as given by the following model:

CT(f,e)=(1/CT₀)exp(−αf((e+e_2)/e_2)),

where f is the spatial frequency (cycles per degree), e is the retinal eccentricity (degrees), CT0 is the minimum contrast threshold, α is the spatial frequency decay constant, and e_2 is the half-resolution eccentricity. Foveated imaging exploits the fact that the spatial resolution of the human visual system decreases dramatically away from the point of fixation (direction of gaze). In order to take this factor into consideration, one embodiment of the present invention uses a plurality of the quantization matrix sets designed for coding the picture regions corresponding to different ranges of retinal eccentricity. The quantization matrix sets can be adaptively selected for each picture region based on the expected point of fixation (direction of gaze) from viewers.

The human gaze location is closely related to the objects of interest in a video scene. In order to take advantage of this factor, one embodiment of the present invention uses a plurality of the quantization matrix sets designed for coding the picture regions corresponding to different levels of human interest. The quantization matrix set can be selected for each picture region based on the expected interest level from the final viewers.

For wide screen display, the human vision is less sensitive to the picture regions away from the display central area than the central area when the eyes are focusing in the central area. Therefore, in one embodiment, a plurality of the quantization matrix sets is used for different regions from the central area of the display. The quantization matrix set can be selected for each picture region considering the different sensitivity to distortion for different regions from the central area of the display under the target viewing conditions.

Since the HVS is less sensitive to high-frequency contents, the conventional quantization matrix designed for natural video tend to quantize high-frequency coefficients with relatively large step size. The video data to be coded may correspond to screen video contents or other mixed video contents, which may have very different characteristics from the natural video scenes. Therefore, the proposed coding system comprises at least one quantization matrix set conventionally designed for natural video contents. The system further comprises at least one quantization matrix set designed for the regions containing computer-generated contents such as text and graphics. The proposed method can adaptively select the quantization matrix set according to the content types in units of slices, CTUs or CUs. In this way, the conventional quantization matrix set will not introduce noticeable artefacts in the local areas with graphics and text.

According to another embodiment of the present invention, quantization setting for a current processing unit in a current picture is derived from the previous frame. Quantization setting can include the quantization matrix or quantization factors mentioned above. For example, the quantization setting may include the syntax element cu_qp_delta_abs as used in HEVC. According to this embodiment, a syntax element can be added in the slice level. When it is turned on, the quantization setting of coding unit in the slice will be derived from the previous frame. For example, the quantization setting can be derived from the co-located pixel in the previous frame. The encoder can first signal a fine granularity quantization setting for a frame, and then signal a slice level syntax element to indicate that the following frames will directly refer the quantization setting of the first frame in order to save data transmitted for quantization setting.

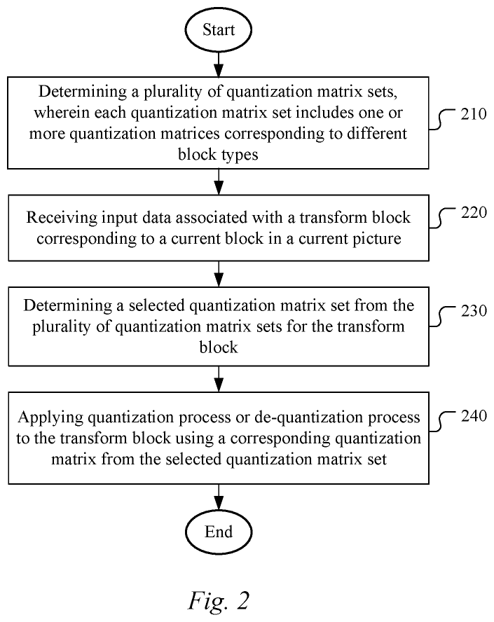

FIG. 2 illustrates a flowchart of an exemplary coding system using transform coding according to an embodiment of the present invention, where multiple quantization matrix sets are used. A plurality of quantization matrix sets are determined in step 210, where each quantization matrix set includes one or more quantization matrices corresponding to different block types. At the encoder side, the encoder will derive the quantization matrix sets and may need to signal information of the quantization matrix sets to the decoder. At the decoder side, the decoder may determine the quantization matrix sets from the video bitstream. Input data associated with a transform block corresponding to a current block in a current picture is received in step 220. At the encoder side, the input data may correspond to transform coefficients of transform blocks to be quantized and entropy coded. At the decoder side, the input data may correspond to decoded quantized transform coefficients to be de-quantized and inverse transformed. A selected quantization matrix set is determined from the plurality of quantization matrix sets for the transform block in step 230. Quantization process or de-quantization process is then applied to the transform block using a corresponding quantization matrix from the selected quantization matrix set in step 240.

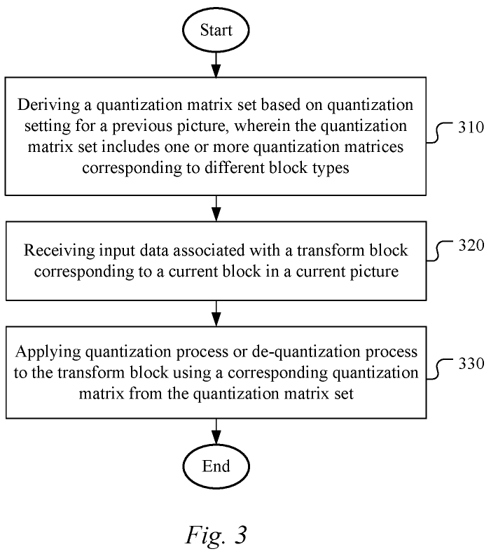

FIG. 3 illustrates a flowchart of an exemplary coding system using transform coding according to an embodiment of the present invention, where the quantization matrix set is determined based on quantization setting of a previous picture. A quantization matrix set is determined based on quantization setting of a previous picture in step 310, where the quantization matrix set includes one or more quantization matrices corresponding to different block types. Input data associated with a transform block corresponding to a current block in a current picture is received in step 320. At the encoder side, the input data may correspond to transform coefficients of transform blocks to be quantized and entropy coded. At the decoder side, the input data may correspond to decoded quantized transform coefficients to be de-quantized and inverse transformed. Quantization process or de-quantization process is then applied to the transform block using a corresponding quantization matrix from the quantization matrix set in step 330.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing transform blocks of video data performed by a video encoder or a video decoder, the method comprising:
determining a plurality of quantization matrix sets, wherein each quantization matrix set includes one or more quantization matrices corresponding to different block types;
receiving input data associated with a transform block corresponding to a current block in a current picture;
determining a selected quantization matrix set from the plurality of quantization matrix sets for the transform block; and
applying quantization process or de-quantization process to the transform block using a corresponding quantization matrix from the selected quantization matrix set.

2. The method of claim 1, wherein said determining the selected quantization matrix set depends on a local region of the current block.

3. The method of claim 2, wherein the local region of the current block corresponds to one picture, one slice, one CTU (coding tree unit) or one CU (coding unit).

4. The method of claim 2, wherein one or more syntax elements indicating the selected quantization matrix set for the local region of the current block are signalled by the video encoder.

5. The method of claim 2, wherein one or more syntax elements indicating the selected quantization matrix set for the local region of the current block are decoded by the video decoder from a video bitstream comprising compressed data of the local region of the current block.

6. The method of claim 1 further comprising signalling information associated with the plurality of quantization matrix sets by the video encoder.

7. The method of claim 1 further comprising deriving the plurality of quantization matrix sets by the video decoder from a video bitstream comprising information associated with the plurality of quantization matrix sets.

8. The method of claim 1 further comprising determining a plurality of quantization factors for controlling quantization step sizes associated with quantization matrices of the plurality of quantization matrix sets.

9. The method of claim 8, wherein values of the plurality of quantization factors are determined independently for different quantization matrix sets.

10. The method of claim 1, wherein different quantization matrix sets are selected for blocks having different slice types or in different temporal layers.

11. The method of claim 1, wherein the plurality of quantization matrix sets is determined for different local regions of a picture corresponding to different levels of human interest.

12. The method of claim 1, wherein the plurality of quantization matrix sets is determined for different local regions of a picture corresponding to different distances away from a picture centre.

13. The method of claim 1, wherein at least one of the plurality of quantization matrix sets is determined for natural-scene video and at least one of the plurality of quantization matrix sets is determined for screen-content video.

14. The method of claim 1, wherein the block types are classified according to block sizes, block shape, block colour component indices, block prediction modes, or a combination thereof.

15. A method of processing transform blocks of video data performed by a video encoder or a video decoder, the method comprising:
deriving a quantization matrix set based on quantization setting for a previous picture, wherein the quantization matrix set includes one or more quantization matrices corresponding to different block types;
receiving input data associated with a transform block corresponding to a current block in a current picture; and
applying quantization process or de-quantization process to the transform block using a corresponding quantization matrix from the quantization matrix set.

16. The method of claim 15, wherein the quantization setting for the previous picture corresponds to the quantization matrix set for a corresponding local region in the previous picture or quantization factors selected for the corresponding local region in the previous picture.

17. The method of claim 15, wherein the quantization setting for the previous picture corresponds to a syntax element specifying an absolute value of a difference between a luma quantization parameter of the current block and a quantization parameter predictor of the current block.

18. The method of claim 15, wherein a syntax element is signalled in a slice level to indicate whether to enable derivation of the quantization matrix set based on the quantization setting for a previous picture.

19. The method of claim 15, wherein the quantization setting for the previous picture is derived from quantization setting of collocated pixels in the previous picture corresponding to the current block.

20. An apparatus for processing transform blocks of video data performed by a video encoder or a video decoder, the apparatus comprising one or more electronic circuits or a processor configured to:
determine a plurality of quantization matrix sets, wherein each quantization matrix set includes one or more quantization matrices corresponding to different block types;
receive input data associated with a transform block corresponding to a current block in a current picture;
determine a selected quantization matrix set from the plurality of quantization matrix sets for the transform block; and
apply quantization process or de-quantization process to the transform block using a corresponding quantization matrix from the selected quantization matrix set.
